(19) United States
(12) Patent Application Publication
(10) Pub. No.: US 2021/0080893 A1
(43) Pub. Date: Mar. 18, 2021

(54) POST-PROCESSING APPARATUS AND IMAGE FORMING SYSTEM

(71) Applicant: Konica Minolta, Inc., Tokyo (JP)

(72) Inventor: Akira TSUNODA, Yokohama-shi (JP)

(21) Appl. No.: 17/012,807

(22) Filed: Sep. 4, 2020

(30) Foreign Application Priority Data
Sep. 18, 2019 (JP) 2019-168951

(51) Int. Cl. G03G 15/00

(52) U.S. Cl. CPC G03G 15/6582; G03G 2215/00814; G03G 15/50

(57) ABSTRACT

Provided is a post-processing apparatus including a cutting unit that cuts a sheet in a width direction orthogonal to a conveyance direction, and that is capable of cutting out part of the sheet as cutting waste, the sheet being conveyed on a conveyance path, a guide that is disposed at an upstream part and/or a downstream part from the cutting unit in the conveyance direction and that is switchable between an open position or a close position; a moving mechanism to move the guide; and a hardware processor that controls the moving mechanism such that the guide is in the open position when the sheet is cut by the cutting unit and that the guide is in the close position when the sheet is conveyed. In the open position, the guide forms a space for the cutting waste to fall down from the conveyance path, and in the close position, the guide shuts the space to guide the sheet to be conveyed.

### CROSS-REFERENCE TO RELATED APPLICATIONS

The entire disclosure of Japanese Patent Application No. 2019-168951 filed on Sep. 18, 2019 is incorporated herein by reference in its entirety.

### BACKGROUND

### Technological Field

The present invention relates to a post-processing apparatus and an image forming system.

### Description of the Related Art

There have been post-processing apparatuses that perform cutting processing on a sheet on which an image is formed by an image forming apparatus to cut ends of the sheet or to cut the sheet into multiple parts. Such a post-processing apparatus includes a cutting unit with upper and lower blades and a trash box to store cutting waste produced by the cutting processing below the cutting unit.

In the post-processing apparatus, the pitch of the conveyance rollers after cutting the sheet in the width direction (CD cutting) is determined according to the minimum FD length (length in the conveyance direction) of the produced sheet. Thus, in a case where a sheet short in the FD direction is produced by the CD cutting, the cutting unit and the conveyance rollers need to be disposed close to each other for the sheet, and consequently, a falling path of cutting waste cannot be kept.

As a solution to such a problem, JP 2015-047657 A discloses a structure in which a set of conveyance roller and driven roller at the upstream part or the downstream part in the conveyance direction in a cutting unit is moved to shift the nip position, for example.

### SUMMARY

However, in JP 2015-047657 A, though a falling path of cutting waste can be kept, there needs space for shifting a pair of conveyance rollers, and a guide on the conveyance path to guide a sheet cannot be disposed, which may deteriorate the conveyance stability.

An object of the present invention is to provide a post-processing apparatus and an image forming system that enable a falling path of cutting waste to be kept with the conveyance stability.

To achieve at least one of the abovementioned objects, according to an aspect of the present invention, a post-processing apparatus reflecting one aspect of the present invention includes:
a cutting unit that cuts a sheet in a width direction orthogonal to a conveyance direction, and that is capable of cutting out part of the sheet as cutting waste, the sheet being conveyed on a conveyance path;
a guide that is disposed at an upstream part and/or a downstream part from the cutting unit in the conveyance direction and that is switchable between an open position or a close position;
   wherein, in the open position, the guide forms a space for the cutting waste to fall down from the conveyance path, and
   wherein, in the close position, the guide shuts the space to guide the sheet to be conveyed,
a moving mechanism to move the guide; and
a hardware processor that controls the moving mechanism such that the guide is in the open position when the sheet is cut by the cutting unit and that the guide is in the close position when the sheet is conveyed.

To achieve at least one of the abovementioned objects, according to another aspect of the present invention, an image forming system reflecting one aspect of the present invention includes:
an image forming apparatus to form an image on a sheet; and
the post-processing apparatus described above.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 shows a configuration of an image forming system 1 according to an embodiment of the present invention;

FIG. 2 is an enlarged view of main components of a CD cutting unit;

FIG. 3A is a perspective view of a guillotine cutter;

FIG. 3B is an enlarged view of a lower blade of the guillotine cutter;

FIG. 3C is a cross-sectional view taken along a line c-c of FIG. 3B;

FIG. 4 is a perspective view of the upstream guide;

FIG. 5 is a perspective view of the scrap guide;

FIG. 6 is an explanatory drawing of an air blower;

FIG. 7 is a block diagram showing a functional configuration of the image forming system;

FIG. 8A is an explanatory drawing of a cutting mode;

FIG. 8B is an explanatory drawing of a cutting mode;

FIG. 8C is an explanatory drawing of a cutting mode;

FIG. 8D is an explanatory drawing of a cutting mode;

FIG. 9 is an explanatory drawing of a motion of the CD cutting unit when the front end of a sheet is cut out;

FIG. 10 is an explanatory drawing of a motion of the CD cutting unit when the back end of a sheet is cut out;

FIG. 11 is an explanatory drawing of a motion of the CD cutting unit when the middle part of a sheet is cut; and

FIG. 12 is an explanatory drawing of a motion of the CD cutting unit in handling of jams.

### DETAILED DESCRIPTION OF THE EMBODIMENTS

Hereinafter, one or more embodiments of the present invention are described in detail with reference to the drawings. However, the scope of the invention is not limited to the disclosed embodiments.

<Configuration>

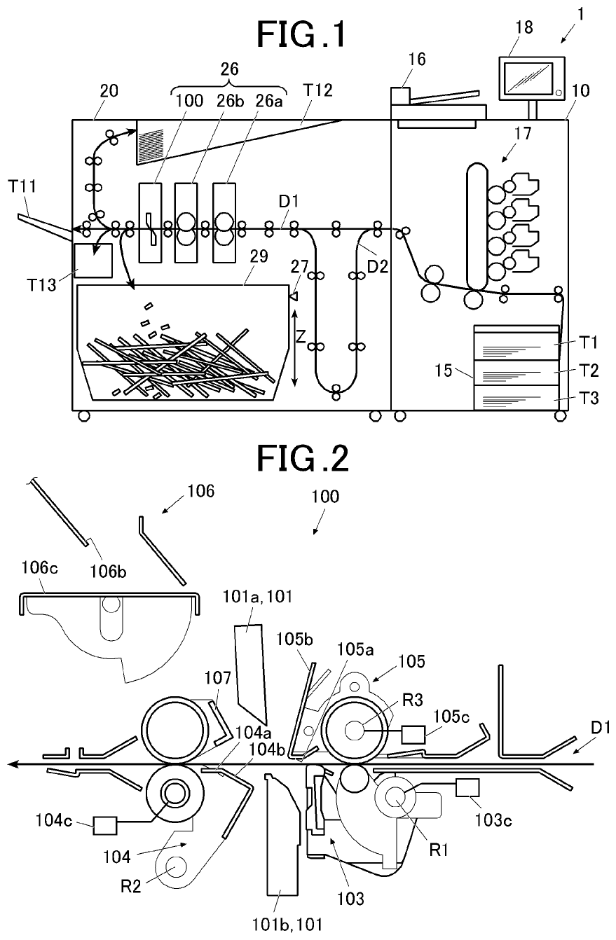

FIG. 1 shows a configuration of an image forming system 1 according to an embodiment of the present invention. The image forming system 1 includes an image forming apparatus 10 to form an image on a paper sheet, and a post-processing apparatus 20 to perform cutting processing on the sheet which the image is formed on by the image forming apparatus 10.

In the image forming system 1 of the present invention, the image forming apparatus 10 and the post-processing apparatus 20 may be configured individually to be conjoined, or may be integrally formed.

The image forming apparatus 10 forms an image on a sheet according to an operation command input via the operation/display interface 18 or a command of image formation received from a personal computer (PC), etc. via the communication network.

The image forming apparatus 10 conveys the sheet after image formation to the post-processing apparatus 20.

The image forming apparatus 10 includes a sheet feeder 15, an image reader 16, an image forming section 17, and an operation/display interface 18.

The sheet feeder 15, which includes multiple sheet feeding trays in which sheets in different sizes, types (paper types), basis weights, etc. can be stored, feeds a sheet in a designated feeding tray T1 to T3 to the image forming section 17.

The image reader 16 reads a document and generates image data. Specifically, in the image reader 16, light is emitted from a light source and reflected on the document, and the reflected light is read by an image sensor or the like.

The image forming section 17 forms an image on the sheet. In the image former 17: a photoreceptor is charged by a charging unit; an electrostatic latent image is formed by scanning exposure of the photoreceptor by a laser beam emitted from the developing unit; the electrostatic latent image is developed with toners by the developing unit; a toner image is transferred onto the sheet by the transfer unit; and the toner image is fixed on the sheet by the fixing unit.

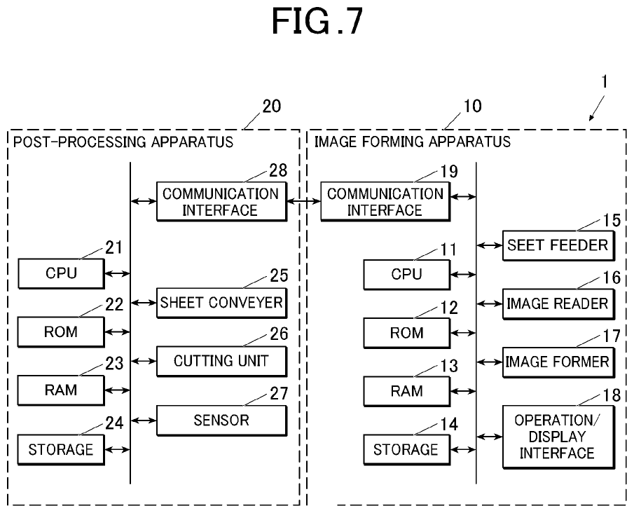

The operation/display interface 18 is formed of a liquid crystal display (LCD), and further includes a display to show various screens, and an operation interface formed of a touch panel overlaid on the display and various keys. In the operation/display interface 18, operation signals input by touch operation or key operation are output to the CPU (central processing unit) 11 (see FIG. 7).

The post-processing apparatus 20 is a cutting apparatus to perform a cutting processing on the sheet. In the post-processing apparatus 20, a cutting processing is performed on the sheet conveyed from the image forming apparatus 10 as necessary, and the product obtained as a result of the cutting processing is ejected to a sheet ejection tray T11, T12 or a card tray T13.

The post-processing apparatus 20 includes a conveyance path D1, a cutting unit 26, a sensor 27, and a scrap box 29.

A long sheet conveyance path D2 branching from the conveyance path D1 and joining the conveyance path D1 at the downstream part is disposed on the conveyance path D1. The long sheet conveyance path D2 is used as a buffer when a long sheet is conveyed.

The cutting unit 26 performs the cutting processing to cut the conveyed sheet. The cutting unit 26 includes FD cutting units 26a, 26b, and a CD cutting unit 100 at multiple positions on the sheet conveyance path D1.

The FD cutting units 26a, 26b include a slitter to cut the sheet in the conveyance direction (Feed Direction). Specifically, the FD cutting unit 26a includes a vertical slitter to cut ends (near side/far side) in the direction perpendicular to the sheet conveyance direction. The FD cutting unit 26b includes a bleed trim slitter to cut margins between the products next to each other in the direction perpendicular to the sheet conveyance direction.

The CD cutting unit 100 includes a guillotine cutter to cut the sheet in the direction perpendicular to the conveyance direction (Cross Direction).

Determination concerning whether or not the FD cutting units 26a, 26b, and/or the CD cutting unit 100 are used is made according to the cutting mode. The cutting mode is a cutting control method determined by the cutting type, and the size, type, basis weight, etc. of the sheet.

The FD cutting units 26a, 26b, and the CD cutting unit 100 of the cutting unit 26 may be each modularized, and may be detachable to the main body of the post-processing apparatus 20. In such a case, the arrangement order of the modules may be switchable.

The sensor 27 detects cutting waste at a predetermined position in the depth direction (Z direction in FIG. 1) in the scrap box 29, and outputs the detection results to the CPU 21 (see FIG. 7). More specifically, the sensor 27 detects whether cutting waste is loaded in the scrap box 29 to a certain amount.

The scrap box 29, which is disposed below the cutting unit 26, stores therein cutting waste produced by the cutting action of the cutting unit 26 and falling from the cutting unit 26. The user opens the door of the post-processing apparatus 20, takes out the scrap box 29, and discards cutting waste in the scrap box 29.

A detailed configuration of the CD cutting unit 100 is described here.

FIG. 2 is an extended drawing showing the main components of the CD cutting unit 100.

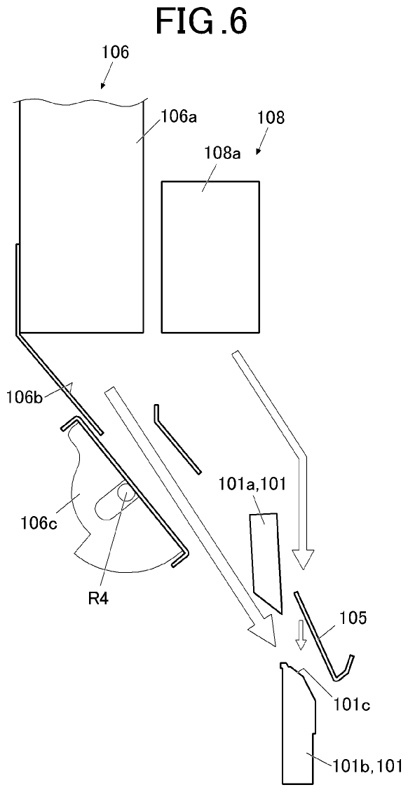

As shown in FIG. 2, the CD cutting unit 100 includes, for example, a guillotine cutter 101 with a upper blade 101a and a lower blade 101b extending in the CD direction of the conveyance path D1, an upstream guide 103 disposed at the upstream part from the lower blade 101b in the FD direction, a downstream guide 104 disposed at the downstream part from the lower blade 101b in the FD direction, a scrap guide 105 disposed facing the upstream guide 103 across the conveyance path D1, an air blower 106 to blow air to the area of the sheet to be cut by the upper blade 101a and the lower blade 101b, and a support air blower 108 (see FIG. 6) to supplementally blow air to the area of the sheet to be cut.

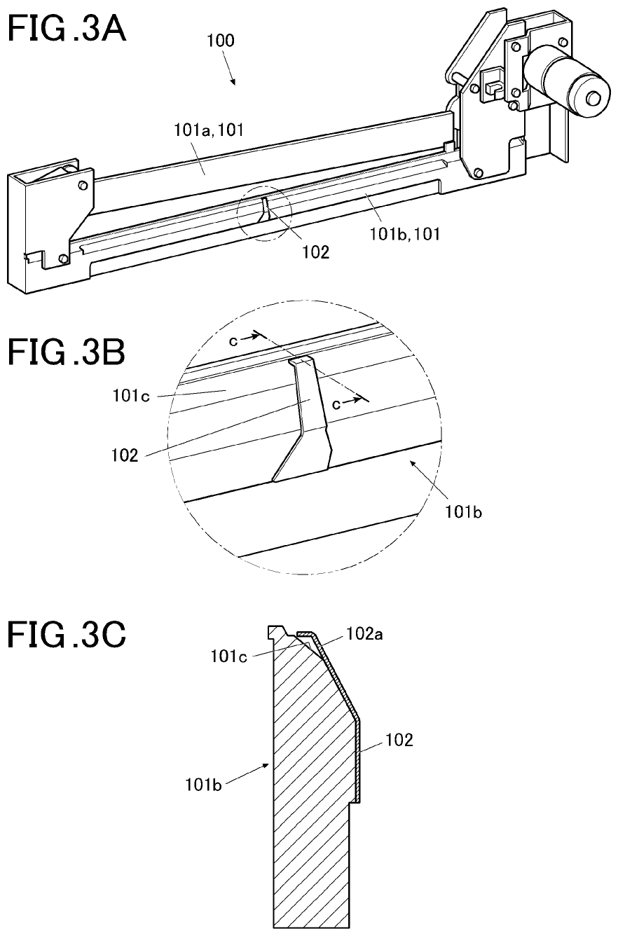

FIG. 3A is a perspective view of the guillotine cutter 101. FIG. 3B is an extended view of the central area of the lower blade 101b of the guillotine cutter 101. FIG. 3C is a cross-sectional view of the lower blade 101b taken along the line c-c in FIG. 3B.

The guillotine cutter 101 includes an upper blade 101a disposed above the conveyance path D1 and a lower blade 101b disposed below the conveyance path D1. The guillotine cutter 101 is disposed with the longitudinal direction being along the direction perpendicular to the conveyance path D1, and, as the upper blade 101a moves downward to the lower blade 101b, the sheet is cut at the cutting position between the upper blade 101a and the lower blade 101b.

As shown in FIGS. 3A to 3C, a board 102, which is an auxiliary member to prevent attachment of cutting waste produced by cutting, is disposed in the central area of the lower blade 101b in the longitudinal direction.

The board 102 is disposed at the upper end of the lower blade 101b such that the upper end 102a of the board 102 is floating from the front end surface (rake face) 101c of the lower blade 101b. In that way, space is made between the lower blade 101b and the produced cutting waste, and the cutting waste are prevented from being attached to the lower blade 101b.

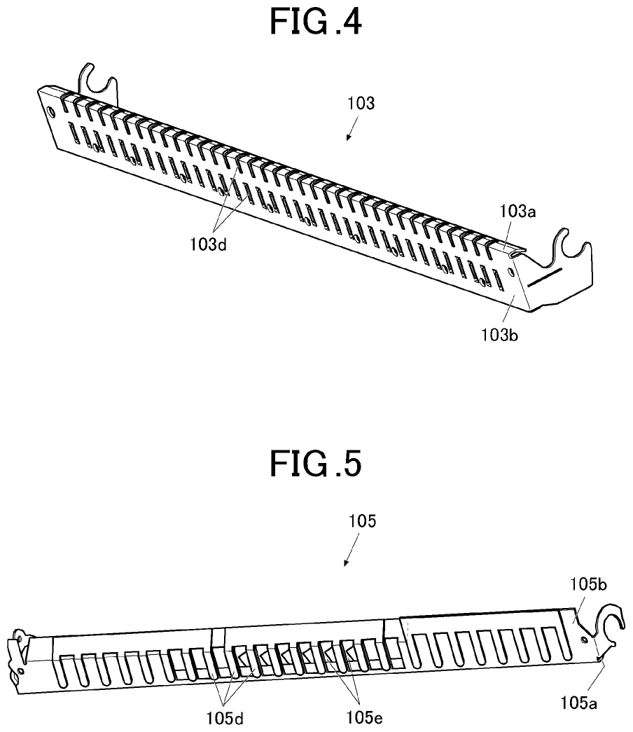

FIG. 4 is a perspective view of the upstream guide 103.

As shown in FIG. 4, the upstream guide 103 is a long member with a conveyance guide 103a and a fall path former 103b. The upstream guide 103 includes an upstream moving mechanism 103c (see FIG. 2) to move (swing) the upstream guide 103 so that one of the conveyance guide 103a and the fall path former 103b functions.

The upstream guide 103 is disposed such that its longitudinal direction is along the CD direction at the upstream part in the FD direction from the lower blade 101b below the conveyance path D1.

The upstream guide 103 can be swung around the rotation axis R1 (see FIG. 2), and may be in a “conveyance guide position (close position)” to function as a conveyance guide of the sheet or in a “path forming position (open position)” to form a conveyance path (fall path) of cutting waste.

In the “conveyance guide position,” the conveyance guide 103a of the upstream guide 103 is substantially parallel to the conveyance path D1. In the “path formation position,” the upstream guide 103 rotates counterclockwise at a predetermined angle from the “conveyance guide position” to form space for a conveyance path of cutting waste on the conveyance path D1 at the upstream part from the lower blade 101b.

As shown in FIG. 4, the upstream guide 103 has ribs 103d extending in the vertical direction at predetermined intervals in the longitudinal direction so as to prevent cutting waste falling in the conveyance path from being attached.

The upstream moving mechanism 103c includes, for example, a rotation axis R1 supporting the upstream guide 103 and a motor rotating the rotation axis R1, and swings the upstream guide 103 as described above, under the control of the CPU 21.

As shown in FIG. 2, the downstream guide 104 is a long member with a conveyance guide 104a and a fall path former 104b. The downstream guide 104 includes a downstream moving mechanism 104c to move (swing) the downstream guide 104 so that the conveyance guide 104a and the fall path former 104b functions.

The downstream guide 104 is disposed such that its longitudinal direction is along the CD direction at the upstream part in the FD direction from the lower blade 101b below the conveyance path D1.

The downstream guide 104 can be swung around the rotation axis R2, and may be in the “conveyance guide position (close position)” to function as a conveyance guide of the sheet, a “path forming position (full-open position)” to form a conveyance path (fall path) of cutting waste, or a “shunt position (half-open position)” to avoid the action of the upper blade 101a.

In the “conveyance guide position,” the conveyance guide 104a of the downstream guide 104 is parallel to the conveyance path D1. In the “path forming position,” space for the conveyance path of cutting waste is formed in the conveyance path D1 at the downstream part from the lower blade 101b as the downstream guide 104 rotates clockwise from the “conveyance guide position” to a predetermined maximum angle. In the “shunt position,” the downstream guide 104 rotates at a smaller angle than in the “path forming position,” and the conveyance guide 104a avoids the conveyance path D1.

Though not shown in the drawings, ribs extending in the vertical direction may be disposed at predetermined intervals on the lower guide 104 so that cutting waste falling from the conveyance path are prevented from being attached.

The downstream moving mechanism 104c includes, for example, the rotation axis R2 to support the downstream guide 104, and a motor to rotate the rotation axis R2, and swings the downstream guide 104 as described above, under the control of the CPU 21.

FIG. 5 is a perspective view of the scrap guide 105.

As shown in FIG. 5, the scrap guide 105 is a long member with a conveyance guide surface 105a and a scrap guide surface 105b. The scrap guide 105 includes a moving mechanism 105c to move (swing) the scrap guide 105 so that the conveyance guide surface 105a or the scrap guide surface 105b functions.

The scrap guide 105 is disposed such that its longitudinal direction is along the CD direction at the upstream part in the FD direction from the upper blade 101a above the conveyance path D1. The scrap guide 105 is disposed mostly facing the upper guide 103.

The scrap guide 105 is swung around the rotation axis R3 (see FIG. 2), and may be in a “conveyance guide position” to function as a conveyance guide of the sheet, a “scrap guide position” to suppress stirring up of cutting waste, or the “jam handling position” to make jam handling possible in case of jam.

In the “conveyance guide position,” the conveyance guide surface 105a of the scrap guide 105 is substantially parallel to the conveyance path D1. In the “scrap guide position,” a guard to cover the lower blade 101b is formed above the lower blade 101b as the scrap guide 105 rotates counterclockwise from the “conveyance guide position” to a predetermined angle. In the “jam handling position,” space for jam handling is formed at the upstream part from the lower blade 101b as the scrap guide 105 rotates clockwise from the “conveyance guide position” at a predetermined angle.

As shown in FIG. 5, ribs 105d extending in the vertical direction are disposed at predetermined intervals in the longitudinal direction on the scrap guide surface 105b, and cutting waste is prevented from being attached.

An opening 105e is formed on the scrap guide surface 105b, and air from above escapes via the opening 105e. And air is blown to prevent the cutting waste from being vertical.

The moving mechanism 105c includes, for example, a rotation axis R3 to support the scrap guide 105 and a motor to rotate the rotation axis R3, and swings the scrap guide 105 under the control of the CPU 21 as described above.

FIG. 6 is an explanatory drawing of the air blower 106 and the support air blower 108.

The air blower 106 is a mechanism for blowing air diagonally downwards to the cutting position between the upper blade 101a and the lower blade 101b.

The air blower 106 includes, for example, a fan 106a to generate air, an air flow path 106b as a circulation path of the generated air, and a shutter 106c as an adjusting mechanism disposed on the air flow path 106b.

The fan 106a may be configured in any way, as long as a predetermined amount of air can be generated. Thus, the fan 106a may be one fan or a combination of multiple fans.

On the air flow path 106b, air is blown diagonally downwards at the downstream part to the cutting position between the upper blade 101a and the lower blade 101b. Specifically, the direction in which air is blown is set so that air flows from the upstream upper part of the upper blade 101a diagonally downwards through the cutting position along the front end slant surface (rake surface) 101c of the lower blade 101b. As air flow is controlled as described above, it can be easier to let cutting waste fall down.

The shutter 106c can be swung around a fulcrum R4 by a driving unit not shown in the drawings so as to move between an open position and a close position. In the open position, air flows away from the air flow path 106b, and in the close position, air is blocked so as not to flow away from the air flow path 106b. In FIG. 6, the shutter 106c is in the open position. Additionally, the shutter 106c is in the close position in FIG. 2, for example.

The opening/closing motion of the shutter 106c makes it possible to start/stop air blow toward the cutting position.

The support air blower 108 includes, for example, a support fan 108a to generate air.

The support fan 108a, which generates a smaller amount of air than the fan 106a, blows air from above toward the position of the lower blade 101b via an air flow path other than the air flow path 106b of the fan 106a.

The air blown by the support fan 108a blows against the scrap guide 105 and then blows out through the opening 105e of the scrap guide 105. This makes it easier for cutting waste to fall down. The air flow path for the support fan 108a may include an adjusting mechanism (shutter) similar to the shutter 106c to make it possible to start and stop air blow toward the cutting position.

Additionally to the above-described configurations, the upstream guide 103, the downstream guide 104, and scrap guide 105 are movable (swung) individually, and are in the predetermined positions according to the cutting mode.

The air blow from the air blower 106 and the support fan 108a is started and stopped according to the cutting mode.

The conveyance guide 107 (see FIG. 2) is fixed at the position substantially opposing the lower guide 104 across the conveyance path D1.

FIG. 7 is a block diagram showing a functional configuration of the image forming system 1.

The image forming apparatus 10 includes a CPU 11, a ROM (read only memory) 12, a RAM (random access unit) 13, a storage 14, the sheet feeder 15, the image reader 16, the image forming section 17, the operation/display interface 18, and the communication interface 19.

Description of the functional components described above is not repeated.

The CPU 11 reads programs stored in the ROM, loads the read programs to the RAM 13, and controls operations of the components of the image forming apparatus 10 in cooperation with the loaded programs.

The ROM 12 includes a non-volatile semiconductor memory, and stores therein, for example, the system program, the various processing programs executable on the system program, and various kinds of data.

The RAM 13 includes a volatile semiconductor memory, and forms a work area for temporarily storing programs read out from the ROM 12, input/output data, and parameters, in various kinds of processing executed by the CPU 11.

The storage 14 includes a hard disk drive (HDD), a non-volatile semiconductor memory, and stores various kinds of data therein.

The communication interface 19, which includes a network interface card (NIC) and a modem, and sends and receives data to/from the post-processing apparatus 20, a PC, and the like.

The post-processing apparatus 20 includes a CPU 21, a ROM 22, a RAM 23, a storage 24, a sheet conveyer 25, a cutting unit 26, a sensor 27, and a communication interface 28.

The CPU 21, the ROM 22, and the RAM 23 are configured similarly to the CPU 11, the ROM 12, and the RAM 13 respectively, except that the target of control of the CPU 21 is the post-processing apparatus 20.

The storage 24 includes an HDD, a non-volatile semiconductor memory, and stores various kinds of data therein.

The sheet conveyor 25 conveys the sheet sent from the image forming apparatus 10 to the sheet ejection tray T11, T12 or the card tray T13.

The communication interface 28 includes an NIC and a modem, and sends and receives data to/from the image forming apparatus 10.

<Actions>

Next, the cutting processing executed in the cutting unit 26 is described.

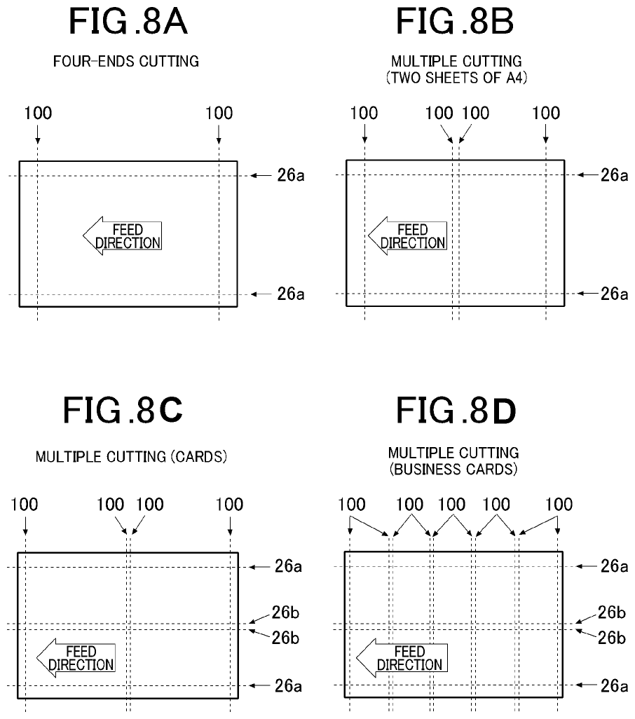

The cutting modes are described with reference to FIGS. 8A to 8D here.

FIG. 8A is an example of cutting in a four-side cutting mode. In the four-side cutting mode, four ends of a sheet are cut out, and one product is obtained from one sheet. Specifically, the opposite ends in the CD direction (far-side end and near-side end) of the sheet are cut out by the FD cutting unit 26a. The front end and the back end in the FD direction of the sheet are cut out by the CD cutting unit 100.

FIGS. 8B to 8D are examples of multiple-cutting modes. In the multiple-cutting modes, the sheet is cut into two or more in addition to the cutting-out of four ends, and multiple products are obtained from one sheet.

In the multiple-cutting mode shown in FIG. 8B, in which an A4-size sheet is cut into two in the FD direction, the opposite ends in the CD direction (far-side end and near-side end) of the sheet are cut out by the FD cutting unit 26a. The front end and the back end in the FD direction of the sheet and a margin between the products next to each other in the FD direction are cut out by the CD cutting unit 100.

In the multiple-cutting mode shown in FIG. 8C for creating cards, the opposite ends in the CD direction (far-side end and front-side end) of the sheet are cut out by the FD cutting unit 26a. Margins between the products next to each other in the CD direction of the sheet are cut out by the FD cutting unit 26b. The ends on the front and back side in the FD direction of the sheet and the margins between the products next to each other in the FD direction are cut out by the CD cutting unit 100.

In the multiple-cutting mode shown in FIG. 8D for creating business cards, the opposite ends in the CD direction (far-side end and near-side end) of the sheet are cut out by the FD cutting unit 26a. Margins between the products next to each other in the CD direction of the sheet are cut out by the FD cutting unit 26b. The front and back ends in the FD direction of the sheet and the margins between the products next to each other in the FD direction are cut out by the CD cutting unit 100.

As a matter of course, details such as the size of the products and the size of the margins can be set on demand. Though the four ends of the sheet are cut out in the examples described above, the ends of the sheet may not be cut out, and the sheet can be cut without margins between the products next to each other.

In any one of the cutting modes, the sheet is cut in the FD direction by the FD cutting unit 26a and/or the FD cutting unit 26b, and reaches the CD cutting unit 100. In the CD cutting unit 100, when the part of the sheet to be cut out reaches the cutting position between the upper blade 101a and the lower blade 101b, conveyance of the sheet is stopped halfway on the conveyance path D1, and the sheet is cut in the CD direction by the guillotine cutter 101.

In the CD cutting unit 100, the components of the CD cutting unit 100 perform predetermined actions according to the cutting mode, that is, depending on the position to be cut on the paper, under the control of the CPU 11 and the CPU 21 (the controller (hardware processor)).

The actions of the components of the CD cutting unit 100 depending on the cutting position of the sheet are described below.

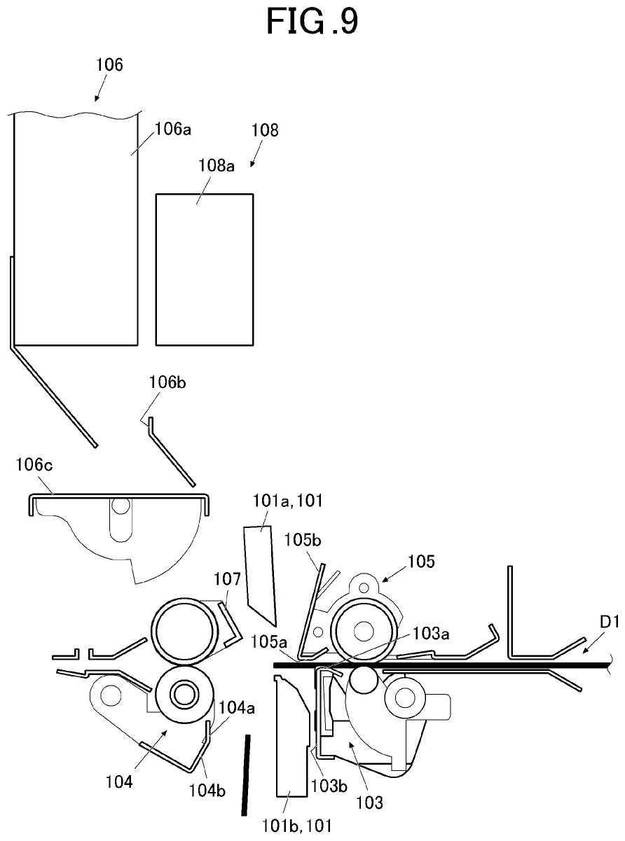

FIG. 9 is an explanatory drawing of the motion when a front end in the FD direction of the sheet is cut out.

As shown in FIG. 9, when the front end of the sheet is cut out, the downstream guide 104 in the “conveyance guide position” shown in FIG. 2 rotates clockwise to the maximum angle (to the full-open position) at the same time as the sheet is cut by the guillotine cutter 101 so as to be in the “path forming position.”

In that way, the conveyance path of cutting waste is formed at the downstream part from the lower blade 101b, and cutting waste produced by cutting out of the sheet front end fall downwards without being interrupted.

After the upper blade 101a is back to the initial position after that, the lower guide 104 is back to the “conveyance guide position” before the front end in the FD direction of the product reaches the nip of the conveyance roller at the downstream part from the downstream guide 104.

The upper guide 103 and the scrap guide 105 are not in operation when the front end of the sheet is cut out as described above.

When the front end of the sheet is cut out as described above, the shutter member 106c of the air blower 106 rotates to the close position, and the air from the air flow path 106b is shut off. Alternatively, the rotation angle of the shutter member 106c may be controlled to decrease the amount of air. The support air blower 108 functions similarly.

In this controlling action, the product is prevented from being caught by the lower blade 101b, folded, or jammed, as air is blown to the front end of the product in the FD direction and the front end is pressed downward.

The air shut off or decreased can flow back after the front end in the FD direction of the product reached the nip of the conveyance roller at the downstream part from the downstream guide 104.

The amount of air from the air flow path 106b may be controlled depending on the length of the product in the CD direction, the basis weight of paper, the type of paper, the image data, presence/absence of curling of the sheet, or the surrounding environment of the apparatus. For example, in a case where the sheet has a basis weight above a predetermined value and is rigid, the amount of air to be decreased may be suppressed, as the amount of air is not affective. The support air blower 108 can be controlled similarly.

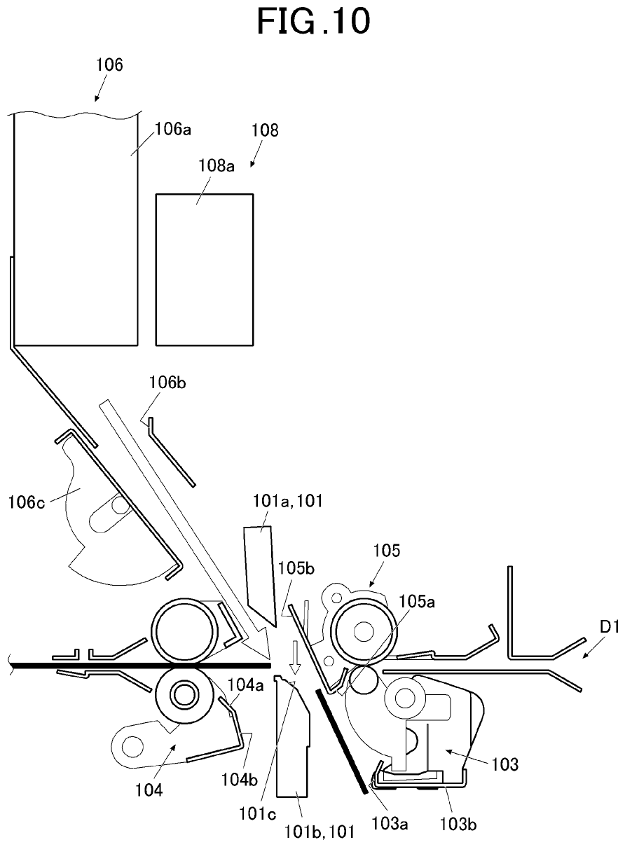

FIG. 10 is an explanatory drawing of the motion when a back end in the FD direction of the sheet is cut out.

As shown in FIG. 10, when the back end of the sheet is cut out, the downstream guide 104 in the “conveyance guide position” shown in FIG. 2 rotates clockwise and stops halfway to the maximum angle (to the half-rotated position) at the same time as the sheet is cut by the guillotine cutter 101 so as to be in the “shunt position”.

In that way, in a case where the guillotine cutter 101 and the downstream guide 104 are disposed near to each other, the action of the upper blade 101a can be prevented from being interrupted with the minimum action of the downstream guide 104. As being “disposed near to each other,” the downstream guide 104 in the “conveyance guide position” as shown in FIG. 2, for example, is disposed below the lower blade 101b.

The upstream guide 103 and the scrap guide 105 rotate counterclockwise at the same time as the guillotine cutter 101 cuts the sheet, to be in the “path forming position” and in the “scrap guide position.”

In that way, a conveyance path of cutting waste is formed at the upstream part from the lower blade 101b, and cutting waste produced by cutting out of the back end of the sheet fall diagonally downwards without being interrupted. A guide is formed above the lower blade 101b and stirring-up of cutting waste is suppressed.

After the upper blade 101a is back to the initial position after that, the lower guide 104 is back to the “conveyance guide position” before the back end in the FD direction of the product reaches the nip of the conveyance roller at the downstream position of the downstream guide 104. After the upper blade 101a is back to the initial position, the upstream guide 103 and the scrap guide 105 are back to the “conveyance guide position” before the front end in the FD direction of the succeeding sheet reaches it.

When the back end of the sheet is cut out as described above, air is blown so that air flows from the air blower 106 along the rake surface 101c of the lower blade 101b so that cutting waste falls down smoothly.

As the lower blade 101b includes the board 102, produced cutting waste may be taken off even if they are electrostatically attached to the lower blade 101b.

Even when cutting waste stirs up by blown air, stirring-up of cutting waste can be suppressed by the scrap guide surface 105b of the scrap guide 105, and it is possible for cutting waste to fall stably.

Air is blown by the support air blower 108 toward the lower blade 101b and blown out through the opening 105e of the scrap guide 105. Thus, even when cutting waste is electrostatically attached to the scrap guide 105, it is possible for cutting scrap to fall with the air.

As the ribs 105d are disposed on the scrap guide 105, the contact area of the scrap guide 105 and cutting waste is smaller, and the force of electrostatic attraction can be reduced.

The ribs 105d prevent cutting waste from being parallel to the air blowing direction, and makes it possible to stably blow air to cutting waste.

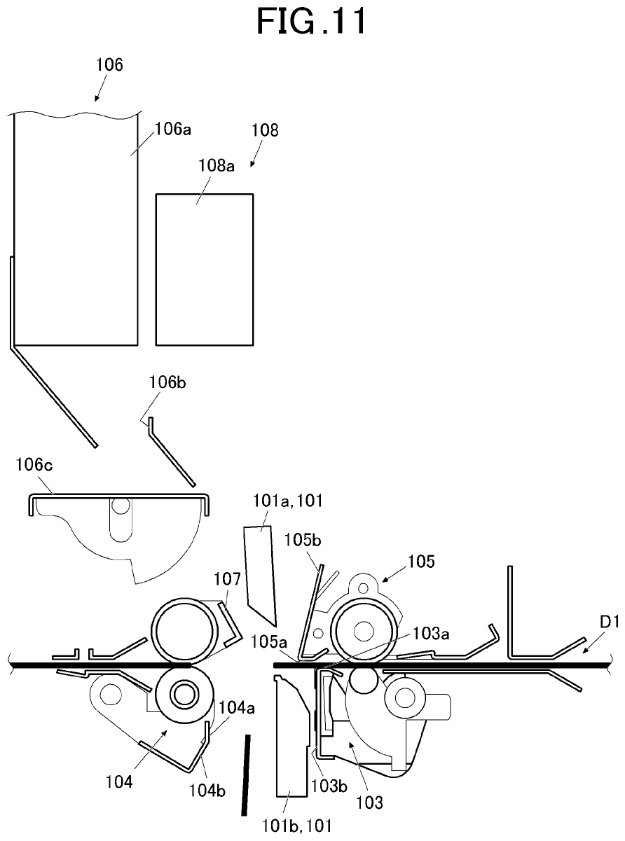

FIG. 11 is an explanatory drawing of the motion of cutting out the middle part in the FD direction of the sheet.

In this action, the margin between the products next to each other in the FD direction is cut out in the multiple-cutting mode for creating cards or business cards shown in FIGS. 8C and 9D. Also in the cutting mode for creating business cards, etc., the front end and the back end in the FD direction of the sheet are cut out similarly to the action described above (see FIGS. 9 and 10).

The sheet is cut twice for each margin so as to cut out the middle part (i.e. margin) of the sheet.

In cutting out the middle part of the sheet, as shown in FIG. 11, when the sheet is cut for the first time, the downstream guide 104 in the “conveyance guide position” shown in FIG. 2 rotates clockwise to the maximum angle at the same time as the sheet is cut by the guillotine cutter 101 to be in the “path forming position.” The downstream guide 104 maintains the “path forming position” until all the margins in the FD direction are cut out.

A conveyance path of cutting waste is formed at the downstream part from the lower blade 101b when one or more margins are cut out, and cutting waste of the margins produced by cutting out of the middle part of the sheet fall down without being interrupted.

After the upper blade 101a is back to the initial position after that, the lower guide 104 is back to the “conveyance guide position” before the front end in the FD direction of the product reaches the nip of the conveyance roller at the downstream part from the downstream guide 104.

When the middle part of the sheet is cut out, the upstream guide 103 and the scrap guide 105 are not in operation.

When the middle part of the sheet is cut out described above, the shutter member 106c of the air blower 106 is controlled so that air from the air flow path 106b is shut out or decreased in the amount.

Though not shown in the drawings, in a case where the sheet is cut in the middle in the FD direction without a margin, the downstream guide 104 in the “conveyance guide position” comes to the “shunt position” at the same time as the sheet is cut by the guillotine cutter 101, and after that, the downstream guide 104 is controlled so as to be back in the “conveyance guide position” before the front end in the FD direction of the product reaches it after the upper blade 101 is back to the initial position.

That is, as cutting waste is not produced, the action of the downstream guide 104 may be minimum so as not to hinder the action of the upper blade 101a.

Here, the downstream guide 103 and the scrap guide 105 are not in operation.

When the sheet is cut without a margin, the shutter 106c of the air blower 106 rotates to the “closed position,” and air from the air blower 106b is blocked. The support air blower 108 operates similarly.

As described above, the actions of the components of the CD cutting unit 100 according to the cutting mode (depending on the cutting position of the sheet) make it possible to establish a falling path of cutting waste without deteriorating the stability of the sheet conveyance. As the direction and the amount of blown air is controlled, it is possible for cutting waste to fall down smoothly without causing an error in conveyance of generated products.

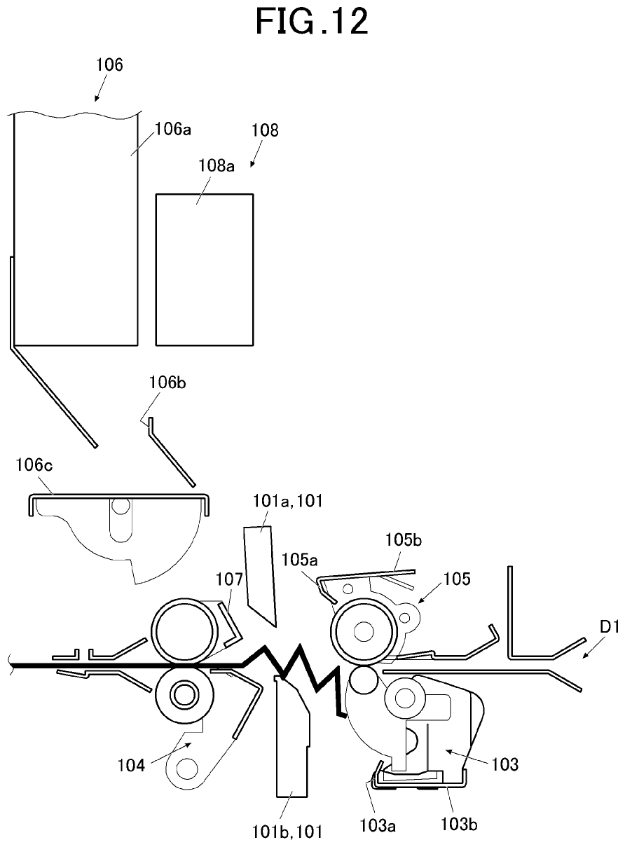

In a case where a jam occurs in the CD cutting unit 100, the scrap guide 105 can rotate clockwise to be in the “jam handling position,” as shown in FIG. 12. In that case, the upstream guide 103 can rotate counterclockwise to be in the “path forming position.” This makes space for handling jams at the upstream part from the lower blade 101b.

In handling jams, the upstream guide 103 and the scrap guide 105 may be manually moved by the user while the action of the CD cutting unit 100 is suspended.

<Effects>

As described hereinbefore, the post-processing apparatus according to the embodiments includes the CD cutting unit 100 that cuts a sheet, which is conveyed on a conveyance path, in the width direction orthogonal to the conveyance direction D1, and that is capable of cutting out part of the sheet as cutting waste; the guide (the upstream guide 103, the downstream guide 104) that is switchable between the open position (in which the guide forms a space for the cutting waste to fall down from the conveyance path) or the close position (in which the guide shuts the space to guide the sheet to be conveyed); the moving mechanism (the upstream moving mechanism 103c, the downstream moving mechanism 104c) to move the guide; and the CPU 21 that controls the moving mechanism such that the guide is in the open position when the sheet is cut by the CD cutting unit 100 and that the guide is in the close position when the sheet is conveyed.

As described above, the guide is in the open position to let cutting waste fall down during the cutting processing, and the guide is in the close position during sheet conveyance. Thus, it is possible to maintain a fall path of cutting waste and ensure the stability of sheet conveyance.

According to the embodiments: the guide includes the upstream guide 103 disposed at the upstream part from the CD cutting unit 100 in the conveyance direction and the downstream guide 104 disposed at the downstream part from the CD cutting unit 100 in the conveyance direction; the moving mechanism includes the upstream moving mechanism 103c to move the upstream guide 103 and the downstream moving mechanism 104c to move the downstream guide 104; and the CPU 21 controls the upstream moving mechanism 103c and the downstream moving mechanism 104c to switch positioning of the upstream guide 103 and positioning of the downstream guide 104 separately.

This enables suitable control according to the cutting position of the sheet.

According to the embodiments: the CD cutting unit 100 includes the upper blade 101a that is disposed above the conveyance path D1 and that is movable up and down, and the lower blade 101b that is disposed below the conveyance path D1; the downstream guide 104 is located below the upper blade 101a in the close position; the downstream moving mechanism 104c swings the downstream guide 104 around a fulcrum; the CPU 21 controls the downstream moving mechanism 104c such that the downstream guide 104 is in the full-open position as the open position when the CD cutting unit 100 cuts the sheet to produce the cutting waste, and the downstream guide 104 is in the half-open position as the open position when the CD cutting unit 100 cuts the sheet without producing the cutting waste; in the full-open position, the downstream guide 104 is rotated to a predetermined maximum angle; and in the half-open position, the downstream guide 104 is rotated to a halfway from the close position to the full-open position.

This makes it possible not to prevent the motion of the upper blade 101a with the minimum action of the downstream guide 104 even in the case where the upper blade 101a and the downstream guide 104 are disposed close to each other.

According to the embodiment, the CPU 21 controls the downstream moving mechanism 104c and the upstream moving mechanism 103c such that, when the CD cutting unit 100 cuts out a front end in the conveyance direction of the sheet as the cutting waste, the downstream guide 104 is in the open position, and the upstream guide 103 is in the close position.

This makes it possible to form a fall path at a position suitable that is suitable when the front end in the sheet conveyance direction is cut out.

The CPU 21 controls the downstream moving mechanism 104c such that the downstream guide 104 is moved from the open position to the close position after the CD cutting unit 100 cuts the sheet before a front end of the rest of the sheet reaches a nip of a conveyance roller at the downstream part from the downstream guide 104 in the conveyance direction.

This makes it possible to ensure the stability of sheet conveyance after the cutting processing.

According to the embodiments, the CPU 21 controls the downstream moving mechanism 104c and the upstream moving mechanism 103c such that when the CD cutting unit 100 cuts out a plurality of sections from a middle part in the conveyance direction of the sheet as the cutting waste, the downstream guide is in the open position when cutting starts and is then kept in the open position until the cutting ends, and the upstream guide 103 is in the close position from when the cutting starts until the cutting ends.

This makes it possible to form a fall path at a position that is suitable when multiple sections at the middle part in the feed direction are cut out.

According to the embodiments, the CPU 21 controls the downstream moving mechanism 104c such that the downstream guide 104 is moved from the open position to the close position after the cutting ends before a front end of the rest of the sheet reaches a nip of a conveyance roller at the downstream part from the downstream guide 104 in the conveyance direction.

This makes it possible to ensure the stability of sheet conveyance after the cutting processing.

According to the embodiments, the CPU 21 controls the downstream moving mechanism 104c and the upstream moving mechanism 103c such that when the CD cutting unit 100 cuts out a back end in the conveyance direction of the sheet as the cutting waste, the downstream guide 104 is in the half-open position, and the upstream guide 103 is in the open position.

This makes it possible to form a fall path at a position that is suitable when the back end in the sheet conveyance direction is cut out.

According to the embodiments: the CPU 21 controls the upstream moving mechanism 103c such that the upstream guide 103 is moved from the open position to the close position after the cutting unit ends cutting before a front edge of the subsequent sheet reaches the upstream guide 103; the CPU 21 controls the downstream moving mechanism 104c such that the downstream guide 104 is moved from the half-open position to the close position before a front end of the rest of the sheet reaches a nip of a conveyance roller at the downstream part from the downstream guide 104 in the conveyance direction.

This makes it possible to ensure the stability of sheet conveyance after the cutting processing.

According to the embodiments, when the CD cutting unit 100 cuts the sheet at the middle part in the conveyance direction without producing the cutting waste, the CPU 21 controls the downstream moving mechanism 104c and the upstream moving mechanism 103c such that the downstream guide 104 is in the half-open position and the upstream guide 103 is in the close position.

This makes it possible to minimize the motion of the downstream guide 104 in the case where the cutting waste is not produced.

According to the embodiments, the CPU 21 controls the downstream moving mechanism 104c such that the downstream guide 104 is moved from the half-open position to the close position after the CD cutting unit 100 cuts the sheet before a front end of the rest of the sheet reaches a nip of a conveyance roller at the downstream part from the downstream guide 104c in the conveyance direction.

This makes it possible to ensure the stability of sheet conveyance after the cutting processing.

The CPU 21 controls the upstream moving mechanism 103c such that in response to an occurrence of a jam in conveyance of the sheet, the upstream guide 103 is moved to the open position.

This makes it easier to deal with jams.

According to the embodiments, the upstream guide 103 includes the fall path former (waste guide surface) 103b that forms a conveyance path of the cutting waste in the open position, and ribs 103d are disposed on the waste guide surface.

This makes it possible for cutting waste to fall down smoothly.

<Misc.>

Various embodiments of the present invention are described above but the embodiments described above are merely preferable examples, and the embodiments are not limited to the above.

For example, in the above-described embodiments, the upstream guide 103, the downstream guide 104, and the scrap guide 105 are configured to be swung, but are not necessarily be swung as long as they can be moved to predetermined positions.

In a case where the length of the cutting waste in the conveyance direction (cutting scrap length) is greater than the length of the space formed on the conveyance path D1 in the conveyance direction (space length) when the guide (the upstream guide 103 and the downstream guide 104) is in the “path forming position,” the cutting action may be repeated more than once so that the cutting scrap length is smaller than the space length, under the control of the CPU 21.

In a case where the length of the part of the sheet to be cut out in the conveyance direction is greater than the length in the conveyance direction of the product created from the sheet, the image forming position is preferably modified by the CPU 21 so that the part to be cut out is distributed to the front-end or back-end side in the sheet conveyance direction in relation to the product.

Though a paper sheet is used as the sheet in the above-described embodiments, the material of the sheet is not limited to paper, and may be a resin sheet, for example.

Although embodiments of the present invention have been described and illustrated in detail, the disclosed embodiments are made for purposes of illustration and example only and not limitation. The scope of the present invention should be interpreted by terms of the appended claims.

What is claimed is:

1. A post-processing apparatus comprising:
a cutting unit that cuts a sheet in a width direction orthogonal to a conveyance direction, and that is capable of cutting out part of the sheet as cutting waste, the sheet being conveyed on a conveyance path,
a guide that is disposed at an upstream part and/or a downstream part from the cutting unit in the conveyance direction and that is switchable between an open position or a close position;
wherein, in the open position, the guide forms a space for the cutting waste to fall down from the conveyance path, and
wherein, in the close position, the guide shuts the space to guide the sheet to be conveyed,
a moving mechanism to move the guide; and
a hardware processor that controls the moving mechanism such that the guide is in the open position when the sheet is cut by the cutting unit and that the guide is in the close position when the sheet is conveyed.

2. The post-processing apparatus according to claim 1,
wherein the guide comprises an upstream guide disposed at the upstream part from the cutting unit in the conveyance direction and a downstream guide disposed at the downstream part from the cutting unit in the conveyance direction,
wherein the moving mechanism comprises an upstream moving mechanism to move the upstream guide and a downstream moving mechanism to move the downstream guide,
wherein the hardware processor controls the upstream moving mechanism and the downstream moving mechanism to switch positioning of the upstream guide and positioning of the downstream guide separately.

3. The post-processing apparatus according to claim 2,
wherein the cutting unit comprises an upper blade that is disposed above the conveyance path and that is movable up and down, and a lower blade that is disposed below the conveyance path,
wherein the downstream guide is located below the upper blade in the close position,
wherein the downstream moving mechanism swings the downstream guide around a fulcrum,
wherein the hardware processor controls the downstream moving mechanism such that the downstream guide is in a full-open position as the open position when the cutting unit cuts the sheet to produce the cutting waste, and the downstream guide is in a half-open position as the open position when the cutting unit cuts the sheet without producing the cutting waste,
wherein, in the full-open position, the downstream guide is rotated to a predetermined maximum angle, and
wherein, in the half-open position, the downstream guide is rotated to a halfway from the close position to the full-open position.

4. The post-processing apparatus according to claim 2,
wherein the hardware processor controls the downstream moving mechanism and the upstream moving mechanism such that when the cutting unit cuts out a front end in the conveyance direction of the sheet as the cutting waste, the downstream guide is in the open position, and the upstream guide is in the close position.

5. The post-processing apparatus according to claim 4,
wherein the hardware processor controls the downstream moving mechanism such that the downstream guide is moved from the open position to the close position after the cutting unit cuts the sheet before a front end of a rest of the sheet reaches a nip of a conveyance roller at a downstream part from the downstream guide in the conveyance direction.

6. The post-processing apparatus according to claim 2,
wherein the hardware processor controls the downstream moving mechanism and the upstream moving mechanism such that when the cutting unit cuts out a plurality of sections from a middle part in the conveyance direction of the sheet as the cutting waste, the downstream guide is in the open position when cutting starts and is then kept in the open position until the cutting ends, and the upstream guide is in the close position from when the cutting starts until the cutting ends.

7. The post-processing apparatus according to claim 6,
wherein the hardware processor controls the downstream moving mechanism such that the downstream guide is moved from the open position to the close position after the cutting ends before a front end of a rest of the sheet reaches a nip of a conveyance roller at a downstream part from the downstream guide in the conveyance direction.

8. The post-processing apparatus according to claim 3,
wherein the hardware processor controls the downstream moving mechanism and the upstream moving mechanism such that when the cutting unit cuts out a back end in the conveyance direction of the sheet as the cutting waste, the downstream guide is in the half-open position, and the upstream guide is in the open position.

9. The post-processing apparatus according to claim 8,
wherein the hardware processor controls the upstream moving mechanism such that the upstream guide is moved from the open position to the close position after the cutting unit ends cutting before a front edge of a subsequent sheet reaches the upstream guide, and
wherein the hardware processor controls the downstream moving mechanism such that the downstream guide is moved from the half-open position to the close position before a front end of a rest of the sheet reaches a nip of a conveyance roller at a downstream part from the downstream guide in the conveyance direction.

10. The post-processing apparatus according to claim 3,
wherein, when the cutting unit cuts the sheet at a middle part in the conveyance direction without producing the cutting waste, the hardware processor controls the downstream moving mechanism and the upstream moving mechanism such that the downstream guide is in the half-open position and the upstream guide is in the close position.

11. The post-processing apparatus according to claim 10,
wherein the hardware processor controls the downstream moving mechanism such that the downstream guide is moved from the half-open position to the close position after the cutting unit cuts the sheet before a front end of a rest of the sheet reaches a nip of a conveyance roller at a downstream part from the downstream guide in the conveyance direction.

12. The post-processing apparatus according to claim 2, wherein the hardware processor controls the upstream moving mechanism such that in response to an occurrence of a jam in conveyance of the sheet, the upstream guide is moved to the open position.

13. The post-processing apparatus according to claim 1,
wherein the guide comprises a waste guide surface that forms a conveyance path of the cutting waste in the open position, and
wherein a rib is disposed on the waste guide surface.

14. An image forming system comprising:
an image forming apparatus to form an image on a sheet; and
the post-processing apparatus according to claim 1.
